(19) United States
(12) Patent Application Publication
(10) Pub. No.: US 2009/0172475 A1
(43) Pub. Date: Jul. 2, 2009

(54) REMOTE RESOLUTION OF SOFTWARE PROGRAM PROBLEMS

(75) Inventor: Mark Carl HAMPTON, Newtown (AU)

Correspondence Address: IBM CORP.;c/o SAWYER LAW GROUP LLP, P.O. BOX 51418, PALO ALTO, CA, 94303, US

(73) Assignee: INTERNATIONAL BUSINESS MACHINES CORPORATION, Armonk, NY (US)

(21) Appl. No.: 11/968,382

(22) Filed: Jan. 2, 2008

(51) Int. Cl. G06F 11/36; G06F 11/32

(52) U.S. Cl. 714/38; 714/57; 714/E11.207; 714/E11.187

(57) ABSTRACT

Method, system, and computer program product for remotely resolving problems in software programs are provided. A problem is detected in a software program. An instant message is sent to an operator to notify the operator of the problem detected in the software program. An instant message is received from the operator. The instant message from the operator includes selection of a resolution option for the problem detected in the software program. The selected resolution option is then carried out.

### BACKGROUND

When a problem is detected in a software program executing on a computer system and the problem is one that is recoverable through action by an operator, the operator is typically notified of the problem through the computer system (e.g., an error message displayed on a screen). The operator, however, must be monitoring the computer system in order to receive notification of the problem and take action.

To ensure that the operator receives notification of the problem without having to continually monitor the computer system, a page or an email could be sent to the operator. However, after receiving notification of the problem, the operator will still have to log onto the computer system in order to take action.

### SUMMARY

Method, system, and computer program product for remotely resolving problems in software programs are provided. In one implementation, a problem is detected in a software program. A first instant message is sent to an operator to notify the operator of the problem detected in the software program. A second instant message is received from the operator. The second instant message includes selection of a resolution option for the problem detected in the software program by the operator. The selected resolution option is then carried out.

### DESCRIPTION OF DRAWINGS

FIG. 1 depicts a process for remotely resolving problems in software programs according to an implementation.

FIG. 2 illustrates a computer system according to an implementation.

FIG. 3 shows a process for remotely resolving problems in software programs according to an implementation.

FIG. 4 is a block diagram of a data processing system with which implementations of this disclosure can be implemented.

### DETAILED DESCRIPTION

This disclosure generally relates to remote resolution of problems in software programs. The following description is provided in the context of a patent application and its requirements. Accordingly, this disclosure is not intended to be limited to the implementations shown, but is to be accorded the widest scope consistent with the principles and features described herein.

Software programs executing on computer systems are able to recover from certain problems if operators take corrective action in a timely fashion (e.g., reallocate computer system resources). These problems can be detected by the software programs themselves or by other software programs. In order for operators to take corrective action in a timely fashion, the operators must be notified when these problems occur.

Notifications are typically made through the computer systems, such as displaying error messages on display screens, playing warning sounds through speakers, or the like. This, however, requires operators to actively monitor the computer systems, which may not be possible. Notifications can also be sent via a page, an email, a voicemail, or the like. Operators, however, would still need to log onto the computer systems to take corrective actions.

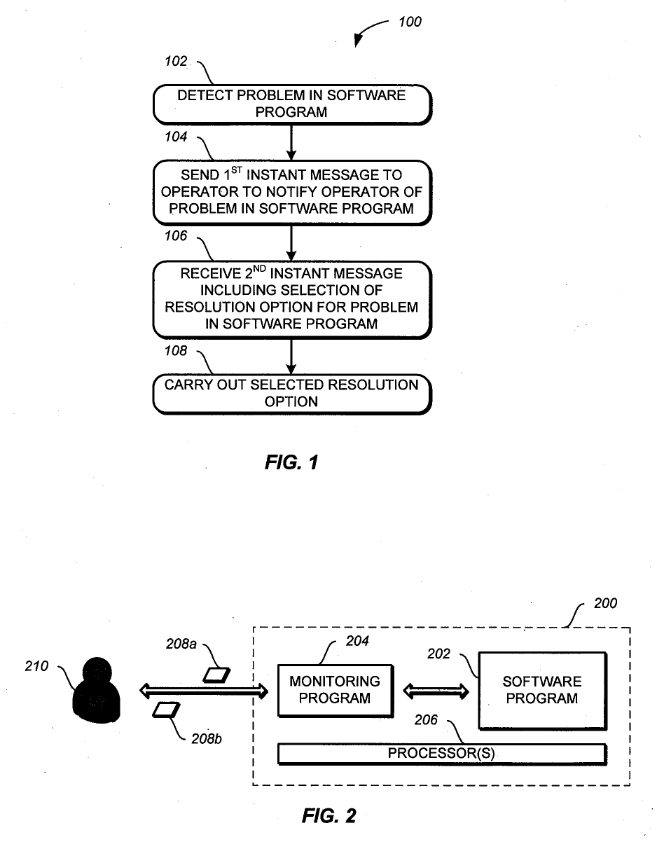

Depicted in FIG. 1 is a process 100 for remotely resolving problems in software programs according to an implementation. At 102, a problem is detected in a software program. The problem may be detected by the software program itself or by a monitoring program separate from the software program. The monitoring program need not be executing on a same computer system as the software program.

At 104, a first instant message is sent to an operator to notify the operator of the problem detected in the software program. The operator may be selected from a plurality of operators based on an availability status of the operator. For example, the availability status of each operator may be set as offline, online and available, online and unavailable, or the like.

The first instant message may include information, such as a description of the problem, timing of the problem (e.g., when the problem occurred, how many times the problem has occurred, etc.), a name of the software program, a name and a location of a computer system on which the software program is executing, or the like. The information may be split into multiple instant messages.

In one implementation, the first instant message is sent to the operator from the computer system on which the software program is executing. The first instant message may be sent to another computer system at which the operator is utilizing. Additionally, the first instant message can be sent to a portable device used by the operator, such as a cellular phone, a personal digital assistant (PDA), or the like.

For purposes of security, the first instant message may also be sent to the operator on a physical or virtual private network. In addition, the first instant message notifying the operator of the problem may not be sent until the operator is authenticated. For example, after the problem is detected in the computer program, an instant message can be sent to the operator requesting authentication information (e.g., login and password). The first instant message is then sent to the operator if the operator provides authentication information in a reply instant message and the authentication information is verified.

A second instant message is received at 106 from the operator. The second instant message includes selection of a resolution option for the problem detected in the software program. In one implementation, the selected resolution option may be one of a plurality of resolution options. The plurality of resolution options may be included in the first instant message to the operator.

At 108, the selected resolution option is carried out. In one implementation, an instant message is sent to the operator to inform the operator of a success or a failure of the resolution option. The instant message may only be sent to the operator if the operator requested to receive such information once the resolution option is completed.

The problem, the operator contacted, the resolution chosen, or the like may be logged and saved for later use. Depending on the resolution option selected, before the selected resolution option is carried out, an instant message may need to be sent to the operator to request additional information, such as amount of memory or disk space to assign, a priority of the resolution option, or the like.

Once the additional information requested is received from the operator via an instant message or if no additional information is needed, a further instant message could be sent to the operator requesting the operator to confirm the selected resolution option and any data provided before the selected resolution option is carried out.

The operator may be given the option to refuse to handle the problem in the software program. For example, in response to the first instant message, the operator may send an instant message changing his or her availability status to busy, unavailable, or the like. To give another example, a time limit could be implemented for receiving responses from operators. Hence, if an operator simply does not respond, then another operator will be selected after the time limit elapses.

Through messaging, an operator no longer has to actively monitor a computer system to receive notice of a software program problem on the computer system or be able to access the computer system to take corrective action. In addition, upon detection of a software program problem, contact with an appropriate and available operator can be immediately initiated. Fallback to any number of alternate operators is also possible if a preferred operator is not available.

FIG. 2 illustrates a computer system 200 according to an implementation. Computer system 200 includes a software program 202 and a monitoring program 204 executing on one or more processors 206. Although monitoring program 204 is illustrated as being separate from software program 202, monitoring program 204 can be incorporated into software program 202. In addition, monitoring program 204 may be executing on a different computer system (not illustrated) that is in communication with computer system 200. Computer system 200 may also include other components (not illustrated), such as storage, memory, another software program, or the like.

Monitoring program 204 is monitoring software program 202 for problems, such as jobs hanging or failing, conflicts between jobs, software program 202 crashing or stalling, or the like. Upon detecting a problem with software program 202, monitoring program 204 will send an instant message 208a to an operator 210 (e.g., system administrator, user, etc.) to notify operator 210 of the problem in the software program.

Operator 210 may be selected from a list of operators based on availability. Availability may be determined by looking up an availability status of operator 210. Availability may also be determined by sending an instant message to operator 210 to find out whether operator 210 is available. Operator 210 can indicate availability via an instant message reply. Unavailability of an operator may also be determined by lack of response from an operator within a predetermined period of time. Thus, instant message 208a may not be the first instant message sent to operator 210. In addition, operator 210 may not be the first operator contacted by monitoring program 204.

Other instant messages (not illustrated) that may be sent to operator 210 before instant message 208a is sent include, for instance, an instant message requesting authentication information (e.g., login and password). Rather than sending a separate instant message to determine availability, monitoring program 204 can simply send the instant message requesting authentication information and wait to see if operator 210 replies.

In FIG. 2, operator 210 replies to instant message 208a with an instant message 208b that includes a selection of a resolution option for the problem detected in software program 202. The selected resolution option may be one of a plurality of resolution options, which can be provided to operator 210 in instant message 208a or in a separate instant message (not illustrated). Operator 210 may also know what resolution options are available without being told.

Additional information may be provided to operator 210 via instant messages. For example, a name and a location of computer system 200, a name of software program 202, a description of the problem, a job associated with the problem, data being processed by the job, error messages, or the like may be provided. Temporal information, such as when the problem occurred, how many times the problem has occurred, or the like, may also be provided. Some or all of this information may be included in instant message 208a or in one or more other instant messages.

After receiving instant message 208b from operator 210, monitoring program 204 carries out the resolution option selected by operator 210. Before carrying out the selected resolution option, additional instant messages (not illustrated) may be communicated between monitoring program 204 and operator 210. For example, monitoring program 204 may request additional information from operator 210 via one or more instant messages (not illustrated). Monitoring program 204 may also request operator 210 to confirm the resolution option selected and any additional data provided.

Likewise, operator 210 may request additional information from monitoring program 204 regarding, for instance, the problem, logs of software program 202, feedback concerning success or failure of the selected resolution option, or the like. If operator 210 requested feedback, after carrying out the selected resolution option, monitoring program 204 will send an instant message to operator 210 to inform the operator of success or failure of the selected resolution option (e.g., whether software program 202 has recovered from the problem).

Communication between monitoring program 204 and operator 210, resolution options carried out by monitoring program 204, and so forth may be logged and stored in computer system 200 for later use. Additionally, all communication between monitoring program 204 and operator 210 may be conducted over a physical or virtual private network (not illustrated). In other implementations, other messaging protocols can be used instead of instant messaging. For example, short message service (SMS), multimedia messaging service, (MMS), or the like may be used instead.

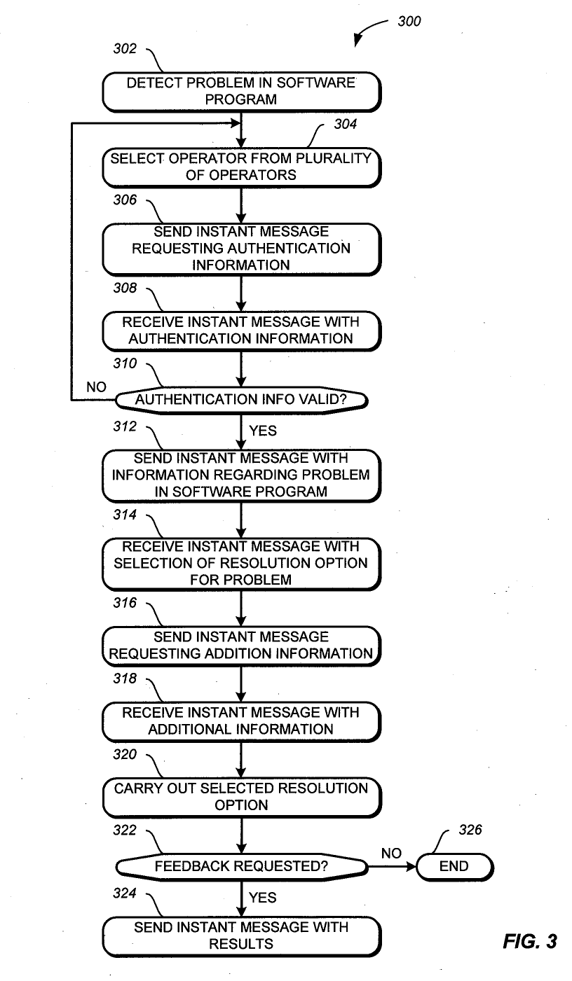

Shown in FIG. 3 is a process 300 for remotely resolving problems in software programs according to an implementation. At 302, a problem is detected in a software program. An operator is selected from a plurality of operators at 304. An instant message is sent to the operator at 306 requesting authentication information.

At 308, an instant message is received from the operator with authentication information. A determination is made at 310 as to whether the authentication information received is valid. If the authentication information is not valid (e.g., the person contacted is not an approved operator), then process 300 returns to 304 to select another operator.

If the authentication information is valid, then at 312, an instant message is sent to the operator with information regarding the problem detected in the software program. An instant message is received at 314 with selection of a resolution option for the problem. Another instant message is sent to the operator at 316 requesting additional information (e.g., confirmation of resolution option selection).

An instant message is received from the operator at 318 with the additional information requested. The selected resolution option is then carried out at 320. A determination is made at 322 as to whether the operator requested feedback on whether the selected resolution option was successful in resolving the problem detected in the software program. If feedback was requested, then an instant message is sent at 324 with results of the selected resolution option. Otherwise, process 300 ends at 326.

This disclosure can take the form of an entirely hardware implementation, an entirely software implementation, or an implementation containing both hardware and software elements. In one implementation, this disclosure is implemented in software, which includes, but is not limited to, application software, firmware, resident software, microcode, etc.

Furthermore, this disclosure can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

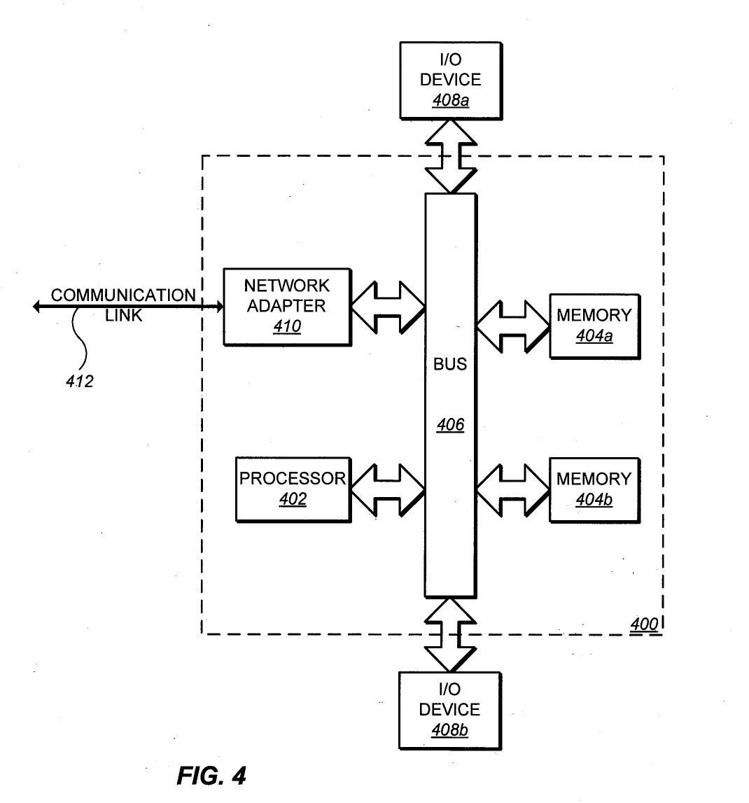

FIG. 4 depicts a data processing system 400 suitable for storing and/or executing program code. Data processing system 400 includes a processor 402 coupled to memory elements 404a-b through a system bus 406. In other implementations, data processing system 400 may include more than one processor and each processor may be coupled directly or indirectly to one or more memory elements through a system bus.

Memory elements 404a-b can include local memory employed during actual execution of the program code, bulk storage, and cache memories that provide temporary storage of at least some program code in order to reduce the number of times the code must be retrieved from bulk storage during execution. As shown, input/output or I/O devices 408a-b (including, but not limited to, keyboards, displays, pointing devices, etc.) are coupled to data processing system 400. I/O devices 408a-b may be coupled to data processing system 400 directly or indirectly through intervening I/O controllers (not shown).

In the implementation, a network adapter 410 is coupled to data processing system 400 to enable data processing system 400 to become coupled to other data processing systems or remote printers or storage devices through communication link 412. Communication link 412 can be a private or public network. Modems, cable modems, and Ethernet cards are just a few of the currently available types of network adapters.

While various implementations for remotely resolving problems in software programs have been described, the technical scope of this disclosure is not limited thereto. For example, this disclosure is described in terms of particular systems having certain components and particular methods having certain steps in a certain order. One of ordinary skill in the art, however, will readily recognize that the methods described herein can, for instance, include additional steps and/or be in a different order, and that the systems described herein can, for instance, include additional or substitute components. Hence, various modifications or improvements can be added to the above implementations and those modifications or improvements fall within the technical scope of this disclosure.

1. A method for remotely resolving problems in software programs, the method comprising:
detecting a problem in a software program;
sending a first instant message to an operator to notify the operator of the problem in the software program;
receiving a second instant message from the operator, the second instant message including selection of a resolution option for the problem detected in the software problem; and
carrying out the selected resolution option in an attempt to resolve the problem detected in the software program.

2. The method of claim 1, further comprising:
selecting the operator from a plurality of operators based on an availability status of the operator.

3. The method of claim 1, wherein the first instant message includes information regarding one or more of the software program, the problem detected in the software program, and a computer system on which the software program is running.

4. The method of claim 1, wherein the selected resolution option is one of a plurality of resolution options provided to the operator in the first instant message.

5. The method of claim 1, wherein prior to carrying out the selected resolution option, the method further comprises:
sending a third instant message to the operator requesting the operator to provide additional information relating to the selected resolution option; and
receiving a fourth instant message from the operator with the additional information requested.

6. The method of claim 1, further comprising:
sending a fifth instant message to the operator informing the operator whether the selected resolution option was successful in resolving the problem detected in the software program.

7. The method of claim 1, wherein the first instant message is sent via a physical or virtual private network.

8. A system comprising:
a processor; and
a monitoring program executing on the processor, the monitoring program detecting a problem in a software program,
sending a first instant message to an operator to notify the operator of the problem in the software program,
receiving a second instant message from the operator, the second instant message including selection of a resolution option for the problem detected in the software problem, and
carrying out the selected resolution option in an attempt to resolve the problem detected in the software program.

9. The system of claim 8, wherein the software program is running on a separate system.

10. The system of claim 8, wherein the monitoring program further selects the operator from a plurality of operators based on an availability status of the operator.

11. The system of claim 8, wherein the first instant message includes information regarding one or more of the software program, the problem detected in the software program, and a computer system on which the software program is running.

12. The system of claim 8, wherein the selected resolution option is one of a plurality of resolution options provided to the operator in the first instant message.

13. The system of claim 8, wherein prior to carrying out the selected resolution option, the monitoring program further
sends a third instant message to the operator requesting the operator to provide additional information relating to the selected resolution option, and
receives a fourth instant message from the operator with the additional information requested.

14. The system of claim 8, wherein the monitoring program further
sends a fifth instant message to the operator informing the operator whether the selected resolution option was successful in resolving the problem detected in the software program.

15. A computer program product comprising a computer readable medium, the computer readable medium being encoded with a computer program for remotely resolving problems in software programs, wherein the computer program, when executed on a computer, causes the computer to:
detect a problem in a software program;
send a first instant message to an operator to notify the operator of the problem in the software program;
receive a second instant message from the operator, the second instant message including selection of a resolution option for the problem detected in the software problem; and
carry out the selected resolution option in an attempt to resolve the problem detected in the software program.

16. The computer program product of claim 15, wherein the computer program further causes the computer to:
select the operator from a plurality of operators based on an availability status of the operator.

17. The computer program product of claim 15, wherein the first instant message includes information regarding one or more of the software program, the problem detected in the software program, and a computer system on which the software program is running.

18. The computer program product of claim 15, wherein the selected resolution option is one of a plurality of resolution options provided to the operator in the first instant message.

19. The computer program product of claim 15, wherein prior to carrying out the selected resolution option, the computer program further causes the computer to:
send a third instant message to the operator requesting the operator to provide additional information relating to the selected resolution option; and
receive a fourth instant message from the operator with the additional information requested.

20. The computer program product of claim 15, wherein the computer program further causes the computer to:
send a fifth instant message to the operator informing the operator whether the selected resolution option was successful in resolving the problem detected in the software program.
